(19) United States
(12) Patent Application Publication
(10) Pub. No.: US 2005/0138033 A1
(43) Pub. Date: Jun. 23, 2005

(54) Methods, applications and systems for deriving content from network resources

(75) Inventors: Robert Katta, Hudson, NH (US); Alexander Ran, Arlington, MA (US); Mitri Abou-Rizk, Newton, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/741,677

(22) Filed: Dec. 19, 2003

(51) Int. Cl. G06F 17/30

(52) U.S. Cl. 707/10

(57) ABSTRACT

Applications, methods and systems are defined that provide for network resources, such as Internet web sites or other networked sites, to be partitioned into multiple logically separable and typically independent information objects, referred to as derived content. The derived content will be defined by various attribute identifiers. The invention provides for storage and access of the derived content based on the attribute identifiers. In addition, the invention provides the ability to identify and extract changed versions of the derived content when the original network resource is altered.

### FIELD OF THE INVENTION

The present invention relates to computer networks and, more specifically, to methods and applications for deriving information from network resources and creating derived resources.

### BACKGROUND OF THE INVENTION

The Internet, commonly referred to as the “Web”, is a worldwide system of computer networks—a network of networks in which users at any one computer can, if they have permission, access information from any other computer. By communicating via the Web, the user has access to an unlimited resource of information.

The web browser is the software application by which users access the Web and conduct, what is commonly referred to as “surfing the web”. The most common web browser applications for a Personal Computer (PC) or the like, are Microsoft® Internet Explorer (manufactured by the Microsoft Corporation, Redmond, Wash. USA) and Netscape® Navigator (manufactured by AOL/Netscape Communications, Mountain View, Calif. USA). In smaller handheld computing devices, like a personal data assistant (PDA), a cellular telephone or the like, display size may limit the use of conventional PC browser applications. These devices typically implement a micro-browser application, also referred to as a mini-browser application, which allow users to access and display specially formatted Internet content.

The Internet or Web includes an enormous amount of information logically linked together through hyperlinks. Web pages usually contain large amounts of information only part of which is relevant for any specific user. Moreover, as a user browses the information on the web it becomes apparent that the useful information that the user desires is distributed over multiple pages and sites and/or buried within pages or sites that contain a voluminous amount of information that is either not important or relevant for the specific user.

At present in order to facilitate recurrent access to personally useful information a user may either copy this information and store it locally or store a Uniform Resource Identifier (URI), i.e., referred to as a “link”, to the page where the information was published when first found by the user. Both methods have significant limitations in that they either fail to address the dynamic nature of information or they fail to allow the user to focus on relevant information.

Storing a local copy of content is only beneficial if the content is static in nature. If the content is dynamic in nature the content will be useful for only a limited period of time dependent upon the rate of change of the original content. For example, a stock quote is only useful for hours, temperatures change constantly, headline news may change several times a day, and even relatively static content like train time table or address information do change over time.

Storage of a URI, such as adding the URI to a web browser favorites listing, only identifies the web page where the useful information may have been previously published. However, web pages typically contain a large amount of information and, in most instances, the user only has an interest in only a small portion of the information provided on the web page or web site. This is especially true with commercial web sites and pages that are typically crowded with advertisements, images, pop-ups and other content not relevant to the user. Therefore, finding relevant information on a web page is often a daunting and difficult task. Moreover, in order for a user to access all the information on the Internet that they desire, they must store multiple URIs and access multiple web pages. Even with high-speed Internet access, accessing multiple web pages is a cumbersome and inefficient method for a user to obtain all the information they desire.

Some of the portal sites on the Internet, such as Yahoo!, Excite, Lycos and the like, allow users to create a personalized web page or site that allows the user to create and manage content that the user deems as desirable. However, this customization is restrictive since it only offers to store and organize links to content served by the specific portal and the links are to entire web sites or pages. Thus, users of such personalized web pages are not at liberty to choose the content of the page from the entirety of network resources.

The information that a user finds useful and relevant on the Internet or any other network source constitutes, what may be appropriately referred to as, the user's “personal content”. This information will be included in numerous different web pages, web sites or other network sources. As such, this “personal content” is not created by or in the control of the user, but rather it is derived from a web page, web site or other networked source owned and managed by a third party, i.e., the original content provider. Thus, for the sake of further discussion, this type of “personal content” may be referred to as “derived personal content”.

Derived personal content may be any information found on a web page, web site, any other web related service or any other networked site. As such, derived personal content may include an article published on a web page, a video clip, news headlines, a digital image, and other type of content derived from content published on a web page or networked site by content providers. For example a user may want access to a subset of real-time stock quotes from a stock broker web site, technology news headlines from news service web site that publishes a variety of news items, a portion of an extensive article published on an entertainment web site, a specific subway route schedule from a mass transit site, and a real-time weather information for a specific locale from a weather site, and the like. Typically, accessing such information is limited to web browser bookmarking of the corresponding network resources associated with the information (i.e., the web page URI) and revisiting each and every bookmarked page or site where relevant information must be found among possibly large amounts of content that is nonessential to the user. As previously discussed, this is an in efficient process.

In addition to the problems related to trying to provide network users the capability to efficiently access information from multiple network resources, another problem related to network resource content management is related to the display of content on small handheld devices having compact display screens. In this situation, the problem of extraneous information being provided on a web site, is further exasperated by the small display associated with the handheld device. These mobile devices typically require data communication over a narrow band network and typically implement a generally small screen or display. Thus, transferring large amounts of unwanted information is inefficient in terms of allocating network resources and adds delay in the user's ability to efficiently and effectively locate desired information. In addition, when extraneous information is provided on a small display screen, the user will typically have to perform some form of scrolling operation in order to locate the specific useful information that the user desires. Once again, unnecessary scrolling adds delay in the user's ability to efficiently and effectively locate desired information and lessens the user's overall level of satisfaction with the browsing function.

Most of the content published on Internet web pages or sites is designed for a typical desktop screen. This makes it difficult for restricted devices, such as mobile phones, personal data assistants (PDAs), etc. to easily access and display this information. Therefore, one approach taken by content providers has been to develop a special version of the content in order to facilitate access by mobile devices. This often leads to information replication and causes many problems associated with management of replicated information. Another approach utilizes automatic trans-coding and reformatting techniques to make the content suitable for access from different devices. However, this approach requires adept technical skills, complex programming, and is typically only implemented by content providers having the financial resources to develop such a special version.

Additionally, some Internet sites use the Cascading Style Sheet (CSS) technology to re-format original content to fit mobile devices. However, this customization requires a substantial re-engineering effort by the site managers because CSS requires manual segmentation of the HTML page, identification of objects and applying new layouts more suitable to mobile devices.

Thus, the need exists to develop methods, applications and computer program products that will allow a user to identify network content of interest and to provide continuous access to the identified network content. The desired application should allow the user to identify any portion of a network resource and to provide the user with dynamic information associated with the identified portion of the network resource. Additionally, the desired application should not require re-engineering on the part of the content provider and should not require any additional technical skills to implement. The desired application should also be capable of being implemented in conjunction with any standard web browser application. In this regard, the desired methods, applications and computer programs should allow a user to select segments of a network resource and to create a secondary network resource that includes the selected segments. The desired application will benefit from being able to provide the user ongoing access to the secondary network resource and dynamic access to the multiple segments that comprise the secondary network resource. Such an application will benefit from avoiding information replication and allowing the user to define the presentation of the segments such that it can be effectively viewed from a chosen device.

### SUMMARY OF THE INVENTION

The present invention defines applications, methods and systems that provide for network resources, such as Internet web sites or other networked sites, to be partitioned into multiple logically separable and typically independent information objects (referred to herein as derived content). Once the segments of derived content have been defined the invention further provides for identifying the derived content in terms of identifying attributes. The invention provides for storage and access to the derived content based upon the assigned identifying attributes. In addition, the invention provides the ability to identify and extract changed versions of the derived content from the original network resource.

In one embodiment of the present invention an application for deriving content from a network resource is defined. The application includes a computer readable storage medium having computer-readable program instructions embodied in the medium. The computer-readable program instructions include first instructions for segmenting information on a network resource to define segments of derivable content, second instructions for selecting one or more segments of derivable content, and third instructions for assigning a plurality of identifying attributes to the one or more selected segments of derivable content. In this regard the derived content is defined by the plurality of identifying attributes.

The invention is further defined by an application for accessing derived content from an associated network resource. The application includes a computer readable storage medium having computer-readable program instructions embodied in the medium. The computer-readable program instructions include first instructions for providing for a plurality of identifying attributes that are associated with content derived from a network resource, second instructions for matching one or more of the plurality of identifying attributes to one or more attributes synthesized from the network resource, and third instructions for providing access to the derived content based on the results of the match. In this regard, the application performs the matching process to ascertain the segment of the network resource that best match the attributes of the previously derived content. Thus, matching the plurality of identifying attributes to attributes synthesized from the network resource may further include instructions for parsing a derived resource identifier to determine the plurality of identifying attributes and a location of the network resource, retrieving the network resource based on the determined location of the network resource, and selecting a segment of the retrieved network resource that best matches the plurality of identifying attributes.

In yet another embodiment of the present invention an application is defined for providing a network user the ability to manage and access derived content from a network resource. The application includes a computer readable storage medium having computer-readable program instructions embodied in the medium. The computer-readable program instructions including first instructions for providing a user the ability to segment information on a network resource to define segments of derivable content, second instructions for providing the user the ability to select one or more segments of derivable content and third instructions for providing the user the ability to access the selected segments of derivable content at a derived resource. In this regard, upon access to the derived resource, information included in the segments of derived content generally reflects current information at the network resource from which the segment was derived.

The invention is additionally defined by methods for deriving content from a network resource, accessing derived content from an associated network resource, and providing a network user the ability to manage and access derived content from a network resource. The steps of these methods generally mirror the corresponding instructions in the above described application embodiments.

Another embodiment of the invention is defined by a system for managing and accessing content derived from a network resource. The system includes a client that. executes an application to access derived content by associating derived content with a plurality of identifying attributes. The system additionally includes a gateway server in communication with the client that executes a second application for interpreting requests from the client for access to derived content and extracting the derived content from the network resource. Lastly, the system includes an origin server in communication with the gateway server that provides the gateway server, upon request, with the network resource.

Thus, the present invention provides for applications, methods and systems for defining content derived from network resources in terms of identifying attributes. The identifying attributes are then stored and used to extract the derived content from the network resource. Extraction of the derived content is achieved by matching the identifying attributes with attributes related to the network resource. As such, the present invention defines network resource content based on an intensional identifier that identifies derived content based on classes or types of instances. In addition, the present invention provides for an application, methods and systems for segmenting network resources, allowing users to select desirable segments as derived content and creating a derived resource that include the derived content. The simplistic method for creating the derived content and the derived resource allow anyone to select and create derived resources, such as personalized derived resource or a condensed derived resource.

### BRIEF DESCRIPTION OF THE DRAWINGS

FIG. 1 is a flow diagram illustrating a method for identifying derived content and creating attribute identifiers for derived content, in accordance with an embodiment of the present invention.

FIG. 2 is a block diagram illustrating the method for IDRI interpretation and extraction of derived content from the original network resource, in accordance with an embodiment of the present invention.

FIG. 3 is block diagram of a system for IDRI interpretation and derived content extraction, in accordance with an embodiment of the present invention.

FIGS. 4-8 are computer screen shots that illustrate the derived resource application being implemented to create a personalized derived resource, in accordance with an embodiment of the present invention.

FIGS. 9-12 are computer screen shots that illustrate the derived resource application being implemented to create a condensed derived resource, in accordance with an embodiment of the present invention.

### DETAILED DESCRIPTION OF THE INVENTION

The present inventions now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present invention provides for methods, applications and computer program products for creating and managing derived content. Derived content may be defined as any portion of information on a network resource, such as a portion of a web page or the like, that a user desires to have access to on a derived network resource, e.g. a personalized web page that includes a collection of portions of multiple web pages. The present invention provides for dynamic access to derived resources, such that, as the derived content is updated on the originating network resource it will also be presented on the derived resource in the updated form.

In conventional networking, such as the Internet, a resource, such as a web page is identified by a Unique Resource Identifier (URI), commonly referred to as the network resource address. The URI defines specific instances, such as an address, a file, content or the like. However, derived content, i.e., segments of a network resource, will typically either not have a URI or be incapable of being identified by a URI.

In the present invention, derived content is identified, not by an address, but rather by a compilation of identifying attributes. This compilation of identifying attributes is referred to herein as the Intensional Derived Resource Identifier (IDRI). The IDRI identifies a class or type of objects pertaining to the derived content. The identifying attributes are subsequently used as correlation attributes in identifying the origin of the derived content.

The identifying attributes included in the IDRI will typically identify the derived content in terms of content, relation to other objects, structure of the resource identified by the URI and other attributes. It should be noted that the identifying attributes will vary depending on the derived content. In other words, some attributes may apply to one form of derived content and not apply to other forms of derived content.

The following provides for a listing of examples of identifying attributes that may be included in an IDRI. It should be noted that the listing herein provided is not exhaustive and other attributes, either defined by the application or defined by the individual deriving the content, may be included as identifying attributes:

A path expression over the document tree.

A path expression over the document layout tree.

The offset from any specified position in the HTML document that represents the original resource.

The length of the derived resource representation.

A tag included in the representation of the derived resource.

A sub-string included in the representation of the derived resource.

Formatting attributes included in the representation of the derived resource.

Metadata describing the derived resource.

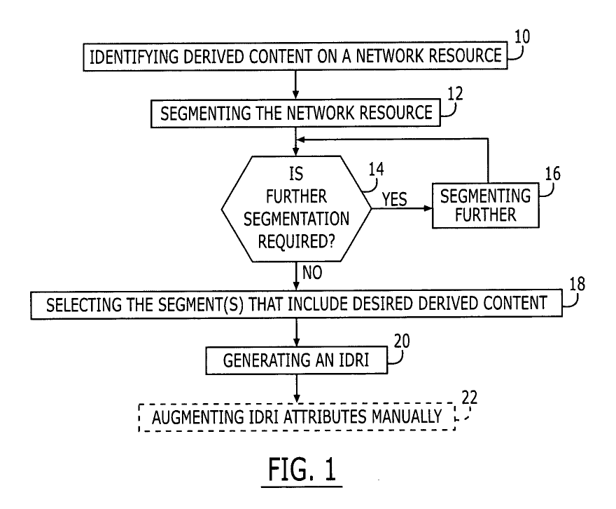

Thus, in one embodiment of the present invention, a method, application and computer program product is defined for identifying derived content and creating attribute identifiers for the derived content. FIG. 1 provides for a flow diagram that illustrates various steps of the method, in accordance with an embodiment of the present invention. At step 10, a user is presented a network resource and identifies content, which they wish to derive. Once the user has identified the desired derived content, at step 12, a network resource segmentation application is implemented to provide the user with identifiable segments of the network resource. The network resource segmentation application may be implemented as a standard browser plug-in, as a script embedded in a web page, or as a standalone application. At step 14, a determination is made as to whether the segments provided define the derived content to the degree necessary. In other words, are the segments over-inclusive, in that they contain more information than the desired derived content calls for, or are they under-inclusive, in that they contain less information than the desired derived content calls for. If a determination is made that the segments provided do not properly define the derived content then, at step 16, further segmentation will occur. The process of further segmentation may occur iteratively until the desired derived content is properly segmented. Once the derived content is properly segmented, at step 18, the user will select the segment that includes the desired derived content.

Upon selection of the segment, at step 20, a derived resource identification application will generate an IDRI for the selected segment. As previously discussed, the DRI will include a compilation of attributes that identify the derived content. The identifying attributes may be encoded using conventional URI syntax; as name value pairs as described by the standard HTTP post method. Additionally, while in this described embodiment the IDRI is created after the user has selected the desired derived content, it is also possible for the application to create IDRIs prior to the user selecting the desired derived content, i.e., each segment presented to the user would have an associated IDRI.

While in most embodiment of the invention the IDRI will be generated solely by the application, it is also possible, and within the inventive concepts herein disclosed, to provide for user input to the attributes that compose the IDRI. At optional step 22, user inputs are made to the identifying attributes, typically in the form of augmenting by adding an attribute or changing the hierarchy of the listed attributes. User inputs may be beneficial in selecting the minimal set of identifying attributes necessary to create a reliable IDRI. For example, a user may identify a sub-string in the representation of the derived content that may be used as a primary key or a user may identify essential formatting attributes of the derived content or other useful identifying attributes. User input to the creation of the IDRI may make the subsequent matching of the IDRI to the originating network resource a more robust process. The subsequent matching of the IDRI to the originating network resource is a novel feature of the invention and will be discussed at length, infra.

Once derived content has been identified and an associated IDRI has been created for the derived content, the user will typically desire to create a platform for derived content within the network. The platform is referred to herein as the derived resource. The derived resource may take many forms, including, but not limited, to a personal derived resource web page or a condensed version of a network resource. A personal derived resource web page allows a user to assemble and present various derived content segments derived from various different network resources. A condensed version of the network resource allows a network resource administrator, i.e., web site administrator, to create a condensed version of a web site suitable for display on the screens of handheld devices. Both of these implementations of the present invention are described at length, infra.

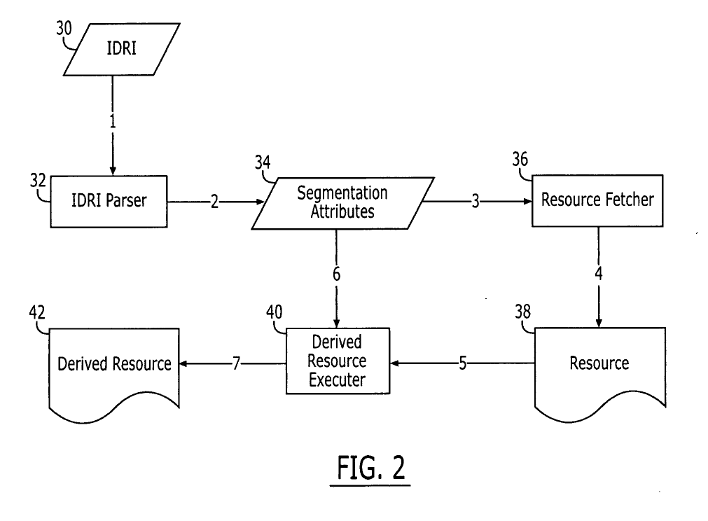

In addition to the inventive concepts of identifying derivable content and creating an IDRI associated with the derived content, a key feature to the present invention is the ability provided by methods, applications and computer program products to interpret the IDRI and to extract the derived content from the original network resource. Interpretation of the IDRI and extraction of the derived content from the original network resource provides the basis for presenting dynamic derived content in the dynamic resource. In this regard, the invention is capable of identifying and extracting changed versions of the derived content from altered versions of the original content. FIG. 2 provides a flow diagram of a method for IDRI interpretation and extraction of derived content from the original network resource, in accordance with an embodied of the present invention. At step 30, a user desires access to the derived content and as such the IDRI associated with the derived content is invoked. At step 32, the DRI is parsed to create a data structure. For example, if the IDRI is encoded using conventional URI syntax it may take the form of the following:
http://www.mobilegw.com?src=http://www.xyz.com/&index=1&b yteSize=6000segmentCount=12
   The parser would parse the IDRI to the following original network resource location: http//www.xyz.com and segmentation attributes would be defined as follows: index=1, bytesize=6000, segment count=12. At step, 34, the segmentation attributes are temporarily stored for subsequent match processing (step 40, which is explained, infra.). At step 36, the original network resource location that has been parsed from the IDRI is used by the resource fetcher to access and obtain the original network resource. At step 38, the original network resource is accessed and the original network resource is obtained.

At step 40, an extraction process ensues to extract from the original network resource the derived content. The extraction process involves implementing a matching routine whereby the identifying attributes of the derived content are matched against attributes synthesized from the network resource to determine which segment within the original network resource best matches the attribute identifiers. Attributes will typically be synthesized from the network resource on an as-needed-basis. This means that attributes will be synthesized from the network resource up until the point at which a match is determined. Thus, if is match is determined early on in the process (based on attribute hierarchy) no further synthesizing of the network resource is required. In alternate embodiments of the invention synthesization of the attributes from the network resource may occur prior to the matching routine. It is noted that the match routine does not require an exact match of attributes, but only requires the output of a best match scenario. Thus, the result of the match process may lead to the derived content being presented in a slightly different form at the derived resource. It is also possible for the match routine to result in no match, in which case, the routine will result in no derived content being provided to the derived resource. At step 42, the derived resource extraction and match process results in a best case match for the IDRI attributes and, thus, a best case approximation of the derived content is provided to the derived resource for presentation purposes.

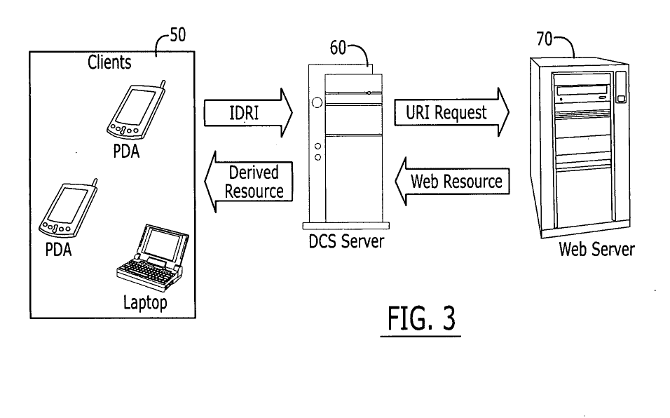

FIG. 3 provides a block diagram representation of a system for IDRI interpretation and derived content extraction, in accordance with an embodiment of the present invention. A network client 50, such as a Personal Data Assistant (PDA), laptop computer, cellular telephone or the like may desire access to derived content. The network client will have communication with memory that stores an IDRI that is associated with derived content. The network client will access the IDRI and communicate the IDRI to server 60. The server will implement a parsing routine that parses the IDRI to determine in an original network resource location and a listing of the attribute identifiers that identify the derived content within the original network resource. Once the parse routine has determined the original network resource location, a network resource fetch routine is implemented to access and obtain the original network resource. The fetch routine processes a URI-type request to communicate with the original network resource server 70.

The original network resource server 70 communicates the original network resource to the server 60. Once the server 60 has received the original network resource it implements an extraction routine to extract the derived content from the original network resource. The extraction process entails matching the attribute identifiers parsed from the IDRI with attributes synthesized from the original network resource to determine a best-case match for the attributes. The results of the matching process define the derived content, which in turn, is communicated to the client 50 and presented to the user of the client as a derived resource.

The server 60 implements the IDRI parse routine and the derived content extraction routine using a variety of conventional server-side technologies, including but not limted to, Common Gateway Interface (CGI) scripts, Java Servlets, Hypertext Preprocessor (PHP) or the like. The routines and applications implemented by the server 60 do not require any novel protocols to process communication between the client 50 and the original network resource server 70. The routines and applications rely on conventional Internet technologies, such as HyperText Mark-up Language (HTML), HyperText Transfer Protocol (HTTP), Javascript, and other standard Internet protocols.

In this regard, FIGS. 1-3 provide for methods, applications and devices according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowcharts support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems that perform the specified functions or steps, or combinations of special purpose hardware and computer instructions.

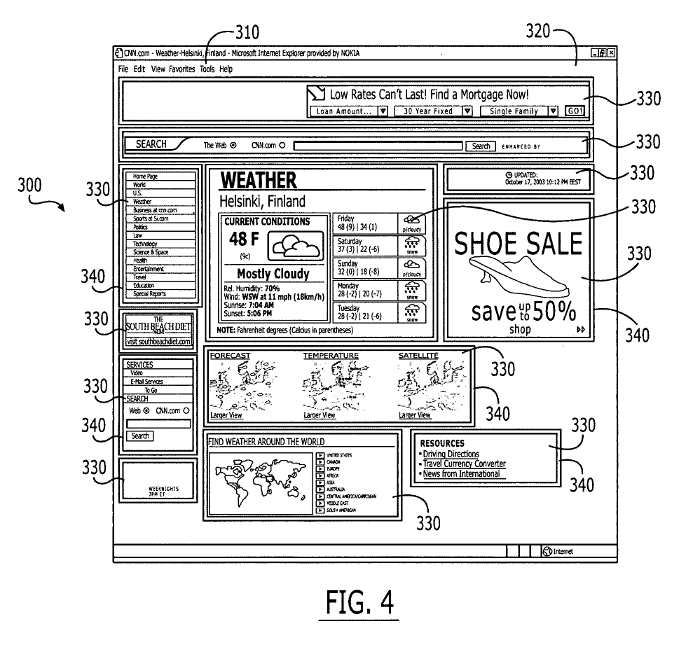

FIGS. 4-12 provide computer screen shots that illustrate various implementations for using the intentional derived resource identifier of the present invention. It should be noted that these implementations are shown by way of example only. As such, these implementations are in no limiting. Other implementations for using the intensional derived resource locator of the present invention are also contemplated and within the scope of the invention.

FIGS. 4-8 provide computer screen shots that illustrate an implementation of the present invention, in which the intensional derived content identifiers, are used to manage derived personal content and to create a derived personal resource. In this embodiment a network user creates a derived personal resource, such as a personal web page or site based on information derived from other network resources, such as Intranet web sites, web services or other networked sites or services.

FIG. 4 is an illustration of an Internet web page 300 and will serve as the starting point for a user desiring creation of a web site/page including derived personal content. It is noted that while in this instance information is being derived from an Internet web site, information may also be derived from any other web service or any other network service external from the Internet. The Internet web page is accessed by the user via a conventional web browser application, such as Microsoft® Internet Explorer or the like. The derived resource application of the present invention will provide for a toolkit, which is typically implemented as a standard web browser plug-in and provides the user with tools for defining derived personal content and creating a derived personal content resource.

The segmentation application of the present invention is accessed via a toolkit (not shown in FIG. 4) within the tools option 310 of the toolbar 320. The toolkit provides for an option for segmenting the displayed information. In the FIG. 4 screen shot the segmentation option has been activated and information segments 330 have been defined. In the illustrated embodiment the information segments are visually identified by a bold frame 340 surrounding the periphery of the segment 330.

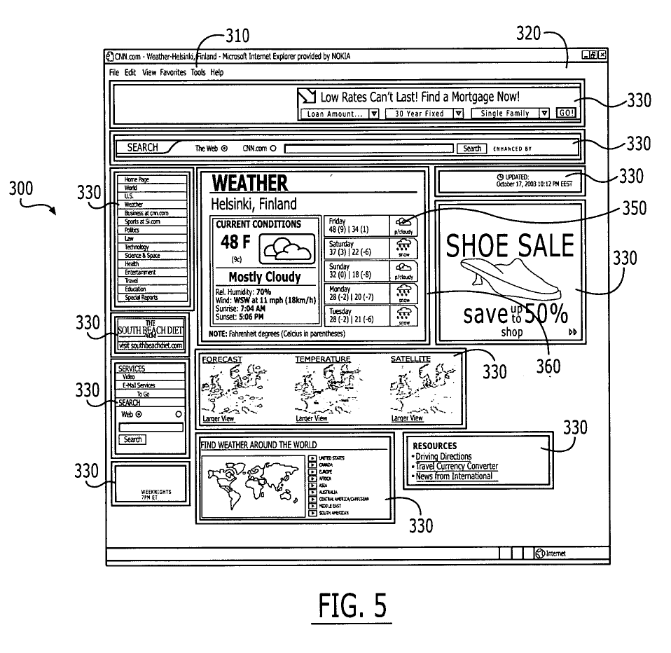

FIG. 5 depicts a computer screen shot of the Internet web page 300, in which the derived resource application is currently being implemented. The content of the page has been segmented into segments 330 and the user has selected a segment 350 for personal content derivation. In the illustrated embodiment the user has selected the segment that includes weather information for Helsinki, Finland. Selection of the desired segment may be by mouse-type function or by keypad entry. In the illustrated embodiment the application has highlighted the segment 350 as being selected by providing for a broken-lined frame 360. It is also possible for the application to highlight the selected segment in any other form, such as changing the color of the frame or otherwise highlighting the content or the frame. The application will typically provide for multiple segments to be selected for inclusion within a user's personal derived resource. For example, in the illustrated embodiment if the user desired both the weather information for Helsinki, Finland and the forecast, temperature and satellite map segment, both would be selected and subsequently highlighted. Alternate interaction mechanisms are possible for segment presentation, identification and selection. One such possibility is to display segments on demand, i.e. initially the user is displayed the original page without any selectable regions but the selectable segmented regions appear automatically as the user moves the pointing device around the resource.

It is also possible for the network content management application to further segment information within a selected segment. i.e., sub-segmentation. For example, in the FIG. 5 illustration, if the user desires only the current temperature information for Helsinki, Finland, the user will select the segment 350 and implement further segmentation of the content of the selected segment. An option within the toolkit will typically be presented to the user to allow the user to further segment the selected segment. Once a segment is further segmented, the content within the segment will be displayed in highlighted form and the user will be able to select from the sub-segments. It should be apparent to those skilled in the art that the process of sub-segmentation may occur iteratively until the user identifies the exact content desired.

Once the user has identified the content on the web page that they wish to derive, a single segment, multiple segments and/or sub-segments, the user will perform a copy and paste operation. It should be noted that this copy and paste operation is not a conventional copy and paste operation in which the contents of the copy and paste operation remain static. The selected segment, i.e., derived content, will have an IDRI associated with it and as such the content derived from this segment will remain generally dynamic as the derived content is presented in a derived resource. The toolkit of the network content management application will typically provide for an option that allows the user to copy the selected segment section(s).

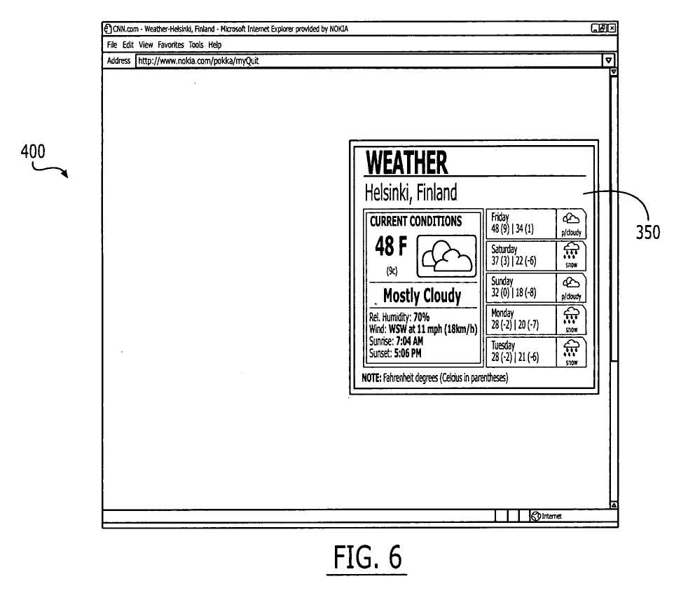

FIG. 6 depicts a computer screen shot of the derived personal resource 400, in which the derived resource application is currently being implemented to assemble the derived personal resource. The toolkit of the network content management application will typically provide for an option that allows the user to paste the selected segment (s) on a derived personal resource, such as a web page. In the illustrated embodiment the user has pasted the selected segment 350, which includes the weather information for Helsinki, Finland.

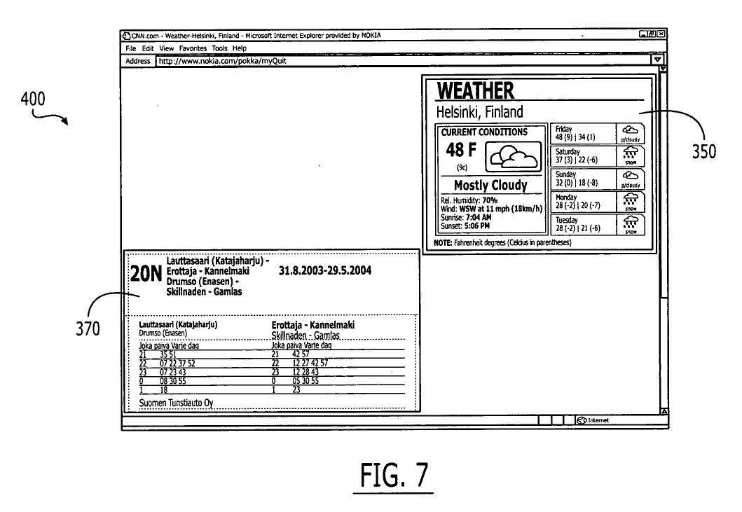

FIG. 7 depicts a computer screen shot of the derived personal resource 400, in which the derived resource application is currently being implemented to assemble further the derived personal resource. In the illustrated embodied the user has identified an additional segment 370 and included the segment within the derived personal resource. The additional segment includes a bus schedule of interest to the user. The additional segment has been derived from an additional web site/page, other than the one used to derive the weather content segment 350. While bus schedule information is typically less dynamic than weather information, the network content management application will provide for the dynamic presentation of information within the bus schedule segment. Thus, when, and if, the bus schedule changes, the segment in the derived personal resource will display the up-to-date current bus schedule.

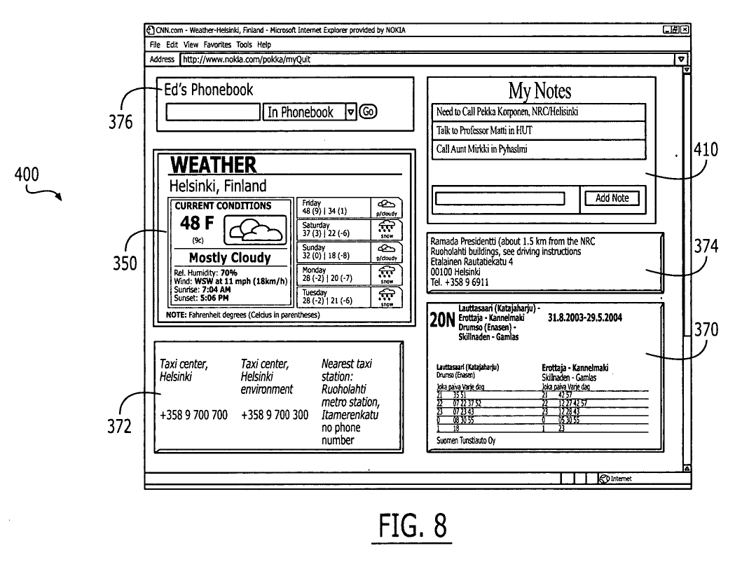

FIG. 8 depicts a computer screen shot of the completed derived resource 400. The user of the derived resource application has identified and assembled a collection of segments 350, 370, 372, 374 and 376. Once the user has assembled the collection of segments, the toolkit may provide for the user to personalize or format the display of the segments. For example, the user may rearrange the layout of the segments or alter the background of the web page. Additionally, the user may alter the information displayed in a segment. For example, in the phone book segment 376 the user has renamed the title of the phone book as a means of personalizing the phone book. The derived resource application may also provide for certain functions to be included within the derived resource. In the illustrated embodiment, the “my notes” feature 410 is not a derived segment, but rather is a feature provided for, as an option, within the derived resource application.

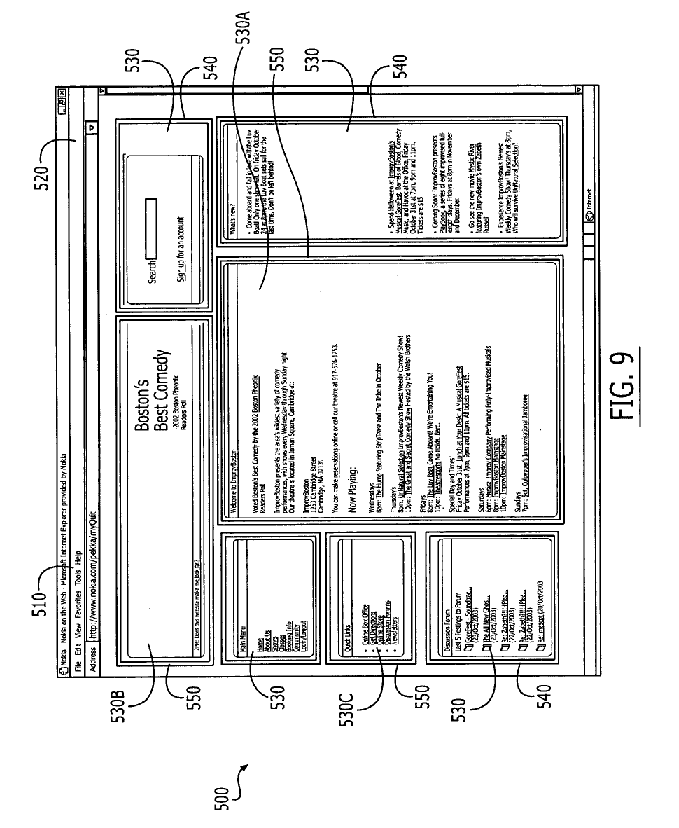

FIGS. 9-12 provide computer screen shots that illustrate another implementation of the present invention, in which the derived resource application is used to create condensed version of a web site or web page. In this implementation the user is typically the web site administrator who desires a condensed version of a web site or web page. The condensed version is typically most applicable for access and display on handheld computing devices that implement a significantly smaller size display than a convention PC or laptop computer.

FIG. 9 is an illustration of an Internet web page 500 and will serve as the starting point for the web site administrator desiring creation of a condensed version. The derived resource application will provide for a toolkit, which is implemented in conjunction with the web browser application and provides the user with tools for identifying information relevant to a condensed version and creating the condensed version of the web page.

The derived resource application is accessed via a toolkit (not shown in FIG. 9) within the tools option 510 of the toolbar 520. The toolkit provides for an option for segmenting the displayed information. In the FIG. 9 screen shot the segmentation option has been activated and information segments 530 have been defined. In the illustrated implementation the information segments are visually identified by a bold frame 540 surrounding the periphery of the segment 530. In addition, in the FIG. 9 illustration the web site administrator has selected multiple segments 530A, 530B and 530C for inclusion in the condensed version of the web site/page. In the illustrated embodiment the application has highlighted the selected segments 530A-C by broken-lined frame 550. It is also possible for the application to highlight the selected segment in any other form, such as changing the color of the frame or otherwise highlighting the content or the frame.

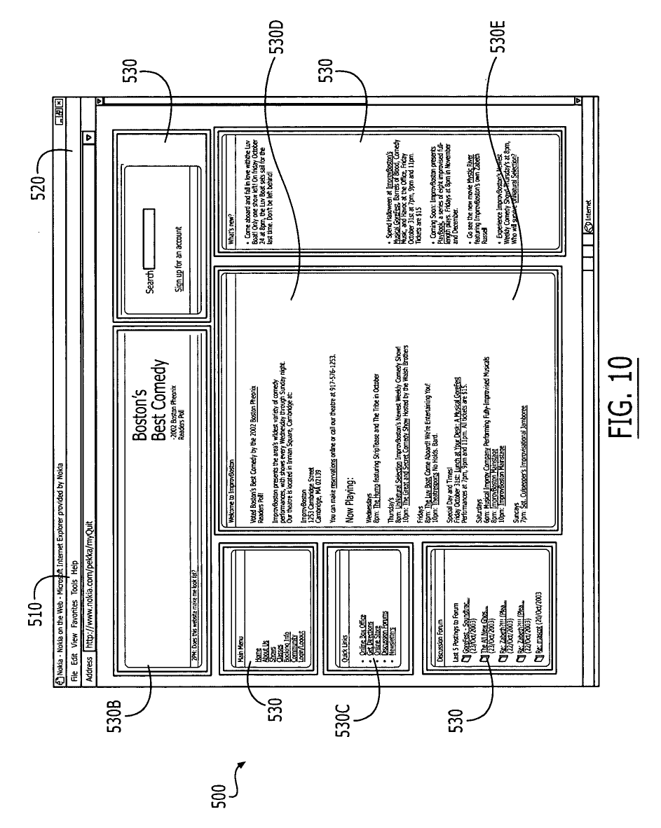

FIG. 10 is an illustration of the Internet web page 500 in which the network content management application has been implemented to adjust the granularity of segmentation. Adjusting the granularity of segmentation allows the owner/manager of the website/page to better identify the information that is desirable for the condensed version of the web site/page. In the illustrated embodiment further segmentation has resulted in previous segment 530A (see FIG. 9) being sub-segmented into two segments 530D and 530E. The toolkit will typically provide for an option within the segmentation process to adjust the granularity of the segmentation to better identify the content of interest. Thus, if the user chooses a fine granularity option the content will be segmented into small segments and if the user chooses a coarse granularity option the content will be segmented into large segments. FIG. 10 illustrates that the web site administrator has selected multiple segments 530B, 530C, 530D and 530E for inclusion in the condensed version of the web site/page.

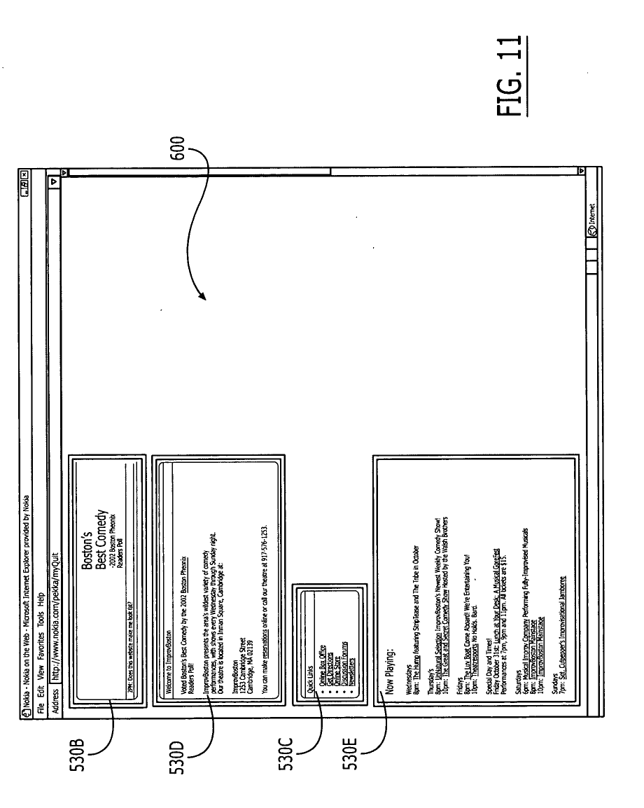

FIG. 11 depicts a computer screen shot of the condensed web page 600, in which the web site administrator has implemented the derived resource application to assemble a condensed version. The toolkit of the network content management application will typically provide for an option that allows the user to paste the selected segment (s) on a condensed web page.

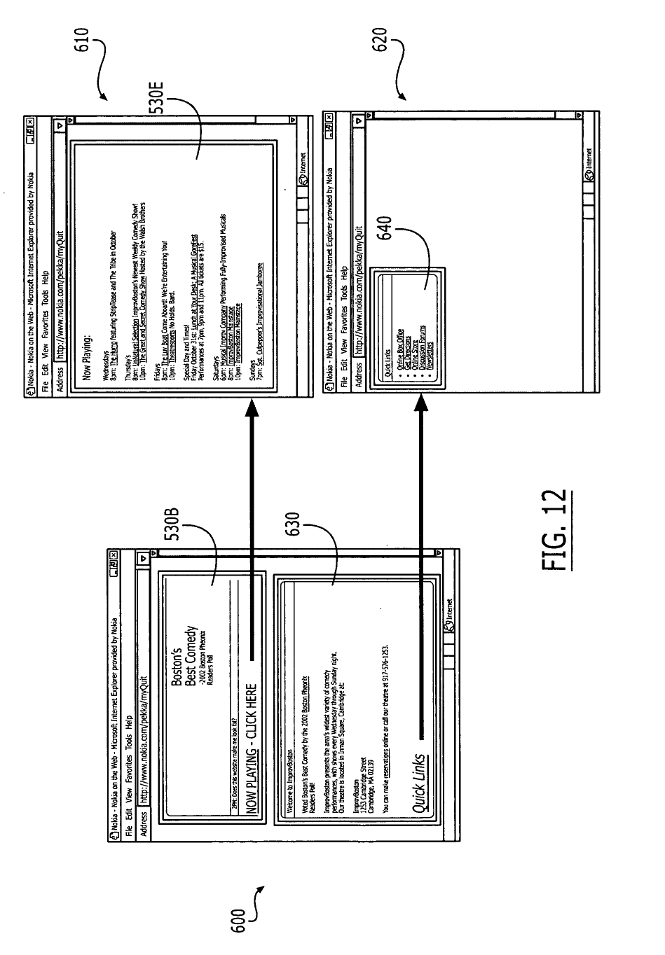

FIG. 12 depicts computer screen shots of the condensed web page 600, in which the web site administrator has implemented the derived resource application to arrange the segments on separate web pages and/or create hyperlinks. In certain instances the volume of information in the condensed version will dictate that the information be presented in multiple web pages. Rather than create a condensed web page that is cluttered or requires a large amount of vertical scrolling to access the information, the site administrator may desire to create multiple pages, with each page being accessed via a hyperlink on a main page. For example, in the illustrated embodiment, the site administrator has chosen to display two segments 530B and 530D on the main page 600 and create additional web pages 610 and 620 for the other two segments 530E and 530C. The derived resource application may provide for creation of hyperlinks 630 and 640 within the main page to provide the user access to the additional web pages 610 and 620.

Thus, the present invention provides for applications, methods and systems for defining content derived from network resources in terms of identifying attributes. The identifying attributes are then stored and used to extract and access the derived content from the network resource. Extraction of the derived content is achieved by matching the identifying attributes with attributes synthesized from the network resource. As such, the present invention defines network resource content based on an intensional identifier that identifies derived content based on classes or types of instances. Additionally the invention provides for applications, methods and systems for segmenting network resources, allowing users to select desirable segments and to create derived network resources that include the selected segments. The simplistic method for creating the derived resource allows any novice user to select and create a derived resource.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. An application for deriving content from a network resource, the application comprising a computer readable storage medium having computer-readable program instructions embodied in the medium, the computer-readable program instructions including:
first instructions for segmenting information on a network resource to define segments of derivable content;
second instructions for selecting one or more segments of derivable content; and
third instructions for assigning a plurality of identifying attributes to each selected segment of derivable content.

2. The application of claim 1, wherein the first instructions for segmenting information on a network resource further comprises instructions for segmenting information on a network resource at various levels of segmentation to allow a user to identify a segment that includes desired derivable content.

3. The application of claim 1, wherein the third instructions for assigning a plurality of identifying attributes to the one or more selected segments of derivable content further defines the identifying attributes as an identifying attribute chosen from the group consisting of content of the segment, relation of the segment to other objects, and the structure of the network resource.

4. The application of claim 1, wherein the third instructions for assigning a plurality of identifying attributes to the one or more selected segments of derivable content further provides for network-user input to the assigning of the plurality of identifying attributes.

5. An application for accessing content derived from an associated network resource, the application comprising a computer readable storage medium having computer-readable program instructions embodied in the medium, the computer-readable program instructions including:
first instructions for providing for a plurality of identifying attributes that are associated with content derived from a network resource;
second instructions for matching one or more of the plurality of identifying attributes to one or more attributes synthesized from the network resource; and
third instructions for providing access to the derived content based on the results of the matching.

6. The application of claim 5, wherein the first instructions for providing for a plurality of identifying attributes that are associated with content derived from a network resource further defines the identifying attributes as an identifying attribute chosen from the group consisting of content of the segment, relation of the segment to other objects, and the structure of the network resource.

7. The application of claim 5, wherein the second instructions for matching one or more of the plurality of identifying attributes to one or more attributes synthesized from the network resource further comprises instructions of:
parsing a derived resource identifier to determine the plurality of identifying attributes and a location of the network resource;
retrieving the network resource based on the determined location of the network resource; and
selecting a segment of the retrieved network resource that best matches the plurality of identifying attributes.

8. The application of claim 5, wherein the third instructions for providing access to the derived content based on the results of the matching of the plurality of identifying attributes to attributes associated with the network resource further comprises providing access to the derived content in the form of a derived resource.

9. An application for providing a network user the ability manage and access derived content from a network resource, the application comprising a computer readable storage medium having computer-readable program instructions embodied in the medium, the computer-readable program instructions including:
first instructions for providing a user the ability to segment information on a network resource to define segments of derivable content;
second instructions for providing the user the ability to select one or more segments of derivable content; and
third instructions for providing the user the ability to access the selected segments of derivable content at a derived resource, wherein, upon access to the derived resource, information included in the segments of derived content generally reflects current information at the network resource from which the segment was derived.

10. The application of claim 9, wherein the first instructions for providing a user the capability to segment information objects associated with a first network resource further comprises instructions for segmenting information on a network resource at various levels of segmentation to allow a user to identify a segment that includes desired derivable content.

11. The application of claim 9, wherein the third instructions for providing the user the ability to access the selected segments of derivable content at a derived resource further provides for accessing the selected segments by accessing a plurality of identifying attributes associated with the selected segments of derived content.

12. A method for deriving content from a network resource, the method comprising the steps of:
segmenting information on a network resource to define segments of derivable content;
selecting one or more segments of derivable content; and
assigning a plurality of identifying attributes to the one or more selected segments of derivable content.

13. The method of claim 12, wherein the step of segmenting information on a network resource further comprises the step of segmenting information on a network resource at various levels of segmentation to allow a user to identify a segment that includes desired derivable content.

14. The method of claim 12, wherein the step of assigning a plurality of identifying attributes to the one or more selected segments of derivable content is further defined as assigning a plurality of identifying attributes to the one or more selected segments of derivable content, wherein the identifying attributes are chosen from the group consisting of content of the segment, relation of the segment to other objects, and the structure of the network resource.

15. The method of claim 12, wherein the step of assigning a plurality of identifying attributes to the one or more selected segments of derivable content further includes the step of providing for network-user input to the assigning of the plurality of identifying attributes.

16. A method for accessing derived content from an associated network resource, the method comprising the steps of:
providing for a plurality of identifying attributes that are associated with content derived from a network resource;
matching the plurality of identifying attributes to attributes associated with the network resource; and
providing access to the derived content based on the results of the matching of the plurality of identifying attributes to attributes synthesized from the with the network resource.

17. The method of claim 16, wherein the step of providing for a plurality of identifying attributes is further defined as providing for a plurality of identifying attributes that are associated with content derived from a network resource, wherein the identifying attributes are chosen from the group consisting of content of the segment, relation of the segment to other objects, and the structure of the network resource.

18. The method of claim 16, wherein the step of matching the plurality of identifying attributes to attributes associated with the network resource further comprises the steps of:
parsing a derived resource identifier to determine the plurality of identifying attributes and a location of the network resource;
retrieving the network resource based on the determined location of the network resource; and
selecting a segment of the retrieved network resource that best matches the plurality of identifying attributes.

19. A method for providing a network user the ability to manage and access content derived from a network resource, the method comprising the steps of:
providing a user the ability to segment information on a network resource to define segments of derivable content;
providing the user the ability to select one or more segments of derivable content; and
providing the user the ability to access the selected segments of derivable content at a derived resource, wherein upon access to the derived resource, information included in the segments of derivable content generally reflects current information at the network resource from which the segment was derived.

20. The method of claim 19, wherein the step of providing a user the capability to segment information objects associated with a first network resource further comprises the step of segmenting information on a network resource at various levels of segmentation to allow a user to identify a segment that includes desired derivable content.

21. The method of claim 19, wherein the step of providing the user the ability to access the selected segments of derivable content at a derived resource further provides for the step of accessing the selected segments by accessing a plurality of identifying attributes associated with the selected segments of derivable content.

22. A system for managing and accessing content derived from a network resource:
a client that executes an application to access derived content by associating derived content with a plurality of identifying attributes;
a gateway server in communication with the client that executes an application for interpreting requests from the client for access to derived content and extracting the derived content from the network resource; and
an origin server in communication the gateway server that provides the gateway server, upon request, with the network resource.

23. The system of claim 22, wherein the second application executed by the gateway server provides for matching a plurality of identifying attributes associated with the derived content to attributes associated with the network resource to determine a best match, wherein the best match defines the segment of the network resource that is to be extracted as the derived content.

24. The system of claim 22, wherein the client executes a client application for segmenting information on a network resource to define segments of derivable content, selecting desired derivable content and presenting the derived content in a derived resource.
